(19) United States
(12) Patent Application Publication
(10) Pub. No.: US 2025/0378049 A1
(43) Pub. Date: Dec. 11, 2025

(54) Methods and Systems to Synchronize Files

(71) Applicant: The Boeing Company, Arlington, VA (US)

(72) Inventor: Michael Paul Werth, Bellevue, WA (US)

(21) Appl. No.: 18/737,368

(22) Filed: Jun. 7, 2024

(51) Int. Cl. G06F 16/178

(52) U.S. Cl. CPC G06F 16/178

(57) ABSTRACT

A method of synchronizing files includes partitioning, based on a template, a first file into a first file portion and partitioning based on the template a second file into a second portion. The method further includes comparing a first value associated with the first portion with a second value associated with the second portion. The method further includes updating the first portion or the second portion based on the comparison.

### TECHNOLOGICAL FIELD

The present disclosure relates generally to the synchronization of data and, more specifically, the present disclosure relates to synchronizing a portion of a file.

### BACKGROUND

File synchronization is a process performed by one or more devices to keep mirrored copies of a file stored on the devices up to date. When a user makes a change to the file on a first device, a file synchronization application will update the stored file copy on a second device and vice versa. The goal of file synchronization is to ensure that the most current version of a file may be accessed by users.

There are several existing file synchronization methods. One method is to copy complete files or directories from one location to another. Copying an entire file or directory has obvious drawbacks in terms of performance and cost, especially when just a specific portion of each file is needed. For example, in the image processing domain, it is common for a small amount of image metadata to exist within the same file as one or more large images. When the metadata is changed, file synchronization is performed on the entire file. In this circumstance, for example, synchronizing 100 gigabytes of image data from a cloud host to read 10 megabytes of changed metadata within the file is inefficient in terms of time and cost.

Another known approach to file synchronization is the rsync. While it can update only portions of a file to match another copy, it has limitations. The rsync relies on file modification timestamps and file sizes to determine synchronization needs, but it cannot differentiate between changes that matter to the user and those that do not. This lack of discrimination is a significant drawback, as in many cases, the user may not want to synchronize all changes made to the file.

Currently, there is a need to limit the extent of synchronization between files to portions of a file identified by a user.

### SUMMARY

One aspect is directed to a method of synchronizing files. The method includes partitioning, based on a template, a first file and a second file into a first portion and a second portion, respectively. The method further includes comparing a first value associated with the first portion with a second value associated with the second portion. In addition, the method includes updating the first portion or the second portion based on the comparing.

In another aspect, the method further includes partitioning the first file and the second file based on one of a first N bytes of the first file and the second file, a last N bytes of the first file and the second file, or a N byte range with an offset in the first file and the second file.

In another aspect, the method further includes partitioning the first file and the second file based on bytes between a first two occurrences of a string in the first file and the second file, or bytes between first occurrences of two different strings in the first file and the second file.

In another aspect, the method further includes partitioning the first file and the second file based on file contents that match a specified schema defined in the template.

In another aspect, the method further includes partitioning the first file and the second file based on file contents that do not match a specified schema defined in the template.

In another aspect, the method further includes determining the first value based on a first checksum of the first portion and determining the second value based on a second checksum of the second portion.

In another aspect, the method further includes updating the first portion or the second portion responsive to the first value being different from the second value.

In another aspect, the method further includes updating the first portion or the second portion based on the comparing includes one of replacing, in a memory, the first portion with the second portion in the second file; or replacing, in the memory, the second portion with the first portion in the first file.

In another aspect, the method includes updating the first portion and the second portion does not include updating a remainder of the first file or the second file.

In one aspect, a method of synchronizing files includes selecting at least one portion of a first file. The method further includes generating a template based on the selecting. The method further includes partitioning, based on the template, the first file and a second file into a first portion and a second portion, respectively. The method further includes determining a first value representing the first portion and a second value representing the second portion. The method further includes comparing the first value and the second value. The method further includes updating the first portion or the second portion based on the comparing.

In another aspect, the method includes selecting the at least one portion of the first file comprises selecting at least one of: a first N bytes of the first file; a last N bytes of the first file; or a N byte range with an offset.

In another aspect, the method includes selecting the at least one portion of the first file comprises selecting bytes between a first two occurrences of a string in the first file, or bytes between first occurrences of two different strings in the first file.

In another aspect, the method includes selecting the at least one portion of the first file comprises selecting first file contents that match a specified schema defined in the template and excluding other contents of the first file.

In another aspect, the method includes selecting the at least one portion comprises selecting first file contents that do not match a specified schema in the template and excluding other file contents that match the specified schema defined in the template.

In another aspect, the method further includes determining the first value based on a first checksum of the first portion and determining the second value based on a second checksum of the second portion.

In another aspect, the method further includes updating the first portion or the second portion responsive to the first value being different from the second value.

In another aspect, the method includes updating comprises one of replacing, in a memory, the first portion with the second portion in the second file or replacing, in the memory, the second portion with the first portion in the first file.

In another aspect, the method includes updating the first portion and the second portion does not include updating a remainder of the first file or the second file.

In one aspect of the present disclosure a non-transitory computer readable medium stores a computer program product to synchronize files. The computer program product includes software instructions that, when run, cause the computer program product to generate a template. The template indicates file portions for partitioning. The computer program product further partitions, based on the template, a first file into first portions and a second file into second portions. The computer program product further determines a first value based on the first portions and determines a second value based on the second portions. The computer program product further compares the first value with the second value. Responsive to the first value being different than the second value, the computer program product further replaces the first portions with the second portions in the second file or replaces the second portions with the first portions in the first file.

In another aspect, the computer program product replaces respective file portions of the first file or the second file without updating a remainder of the first file or the second file.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a schematic diagram of an exemplary system for synchronization.

FIG. 2A-B are schematic diagrams of exemplary client and host devices according to embodiments of the present disclosure.

FIG. 3 is a flowchart illustrating communications between a client device and a host device for performing file synchronization according to embodiments of the present disclosure.

FIG. 4A-E illustrates an exemplary method of file synchronization.

FIG. 5 is a flow chart illustrating a method of synchronizing files according to some aspects of the present disclosure.

FIG. 6 is a flow chart illustrating a method of synchronizing files according to some aspects of the present disclosure.

FIG. 7 is a schematic diagram of a host device.

FIG. 8 is a schematic diagram of a client device.

### DETAILED DESCRIPTION

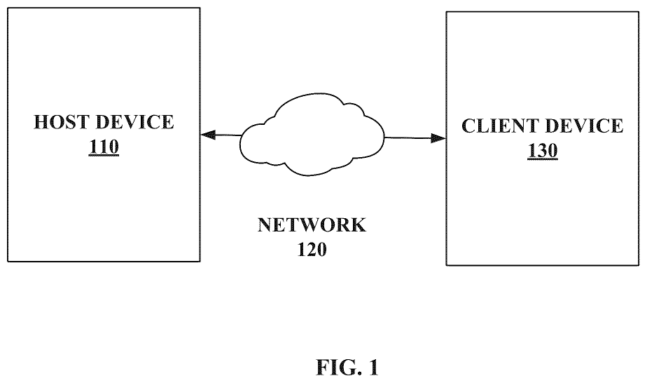

FIG. 1 is a schematic diagram of an exemplary system for synchronizing based on a user defined template. The system includes a host device 110, a client device 130 and a network 120. The host device 110 may be a cloud server configured to communicate with the client device 130. In some examples, the host device 110 is another client device 130. The client device 130 and host device 110 may each communicate via the network 120 (e.g., the internet).

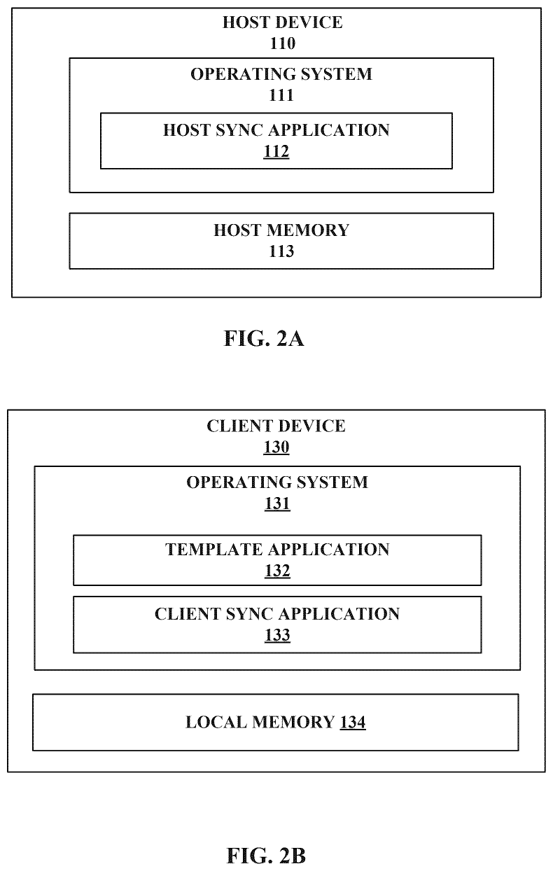

FIG. 2A is a schematic diagram of an exemplary host device 110 for synchronization based on a user defined template. The host device 110 includes an operating system 111 and a host memory 113. The host memory 113 is used to store user data including user files and file directories. Although one memory is depicted in the figure, the host device 110 may include more than one host memory 113. The host memory 113 can include optic disk storage, RAM, ROM, EEPROM, flash memory or any other computer storage medium which can be used to store data.

The operating system 111 is configured to run software programs including a host synchronization application 112 on the host device 110. The host synchronization application 112 is configured to synchronize a file located at the host memory 113 with another file stored at another computing device.

FIG. 2B is a schematic diagram of a client device 130. The client device 130 includes at least one local memory 134. The local memory 134 is used to store user data including a synchronized copy of a file located at the host device 110. The local memory 134 can include optic disk storage, RAM, ROM, EEPROM, flash memory or any other computer storage medium that can store data. The client device 130 may be, for example, a desktop computer, laptop computer, a tablet computer, a personal digital assistant, a smartphone, a tablet computer, or any other computing device capable of running a computer application.

The client device 130 includes an operating system 131 configured to run software programs, including a template application 132 and a client sync application 133. The template application 132 may be used for creating a template file. The template file defines a template based chunking strategy for partitioning a file. The template file may be sent to the client sync application 133 to synchronize the file located at the client device 130 with the file located at the host device 110. In some examples, the template application 132 may be included in the client sync application 133, or the client sync application 113 may be configured to perform the functions of the template application 132.

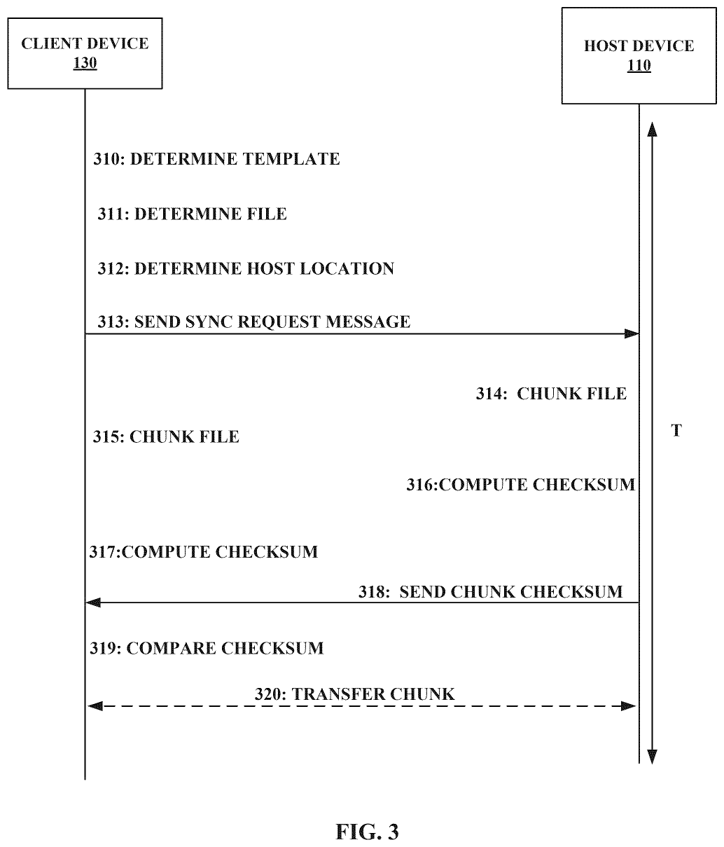

FIG. 3 is a flowchart illustrating communications between a client device 130 and a host device 110 for performing file synchronization by chunking a file according to a user defined template based chunking strategy according to embodiments of the present disclosure.

Template application 132 generates a template indicating a portion of a file to be updated (step 310). The template is used to isolate portions of a file so that the entire file is not updated. Defining a portion of the file to be updated may be useful in situations where the file is large and contains multiple datasets, and only a portion of the file is requested to be updated.

In some examples, the template is a computer-generated algorithm according to criteria set by a user or a manually generated algorithm created by a user. Additionally, or alternatively, the template may be generated according to a timestamp, or a file size determined by a user. For example, the user may only want to change a file's metadata. Metadata is usually found in the first bytes of a file; therefore, the user may indicate that N number of bytes at the beginning of a file should be updated.

Template based chunking strategies may vary. For example, the template may designate a predetermined number of bits appearing at the beginning or end of a file (i.e., first N bytes or last N bytes) for synchronization. In other examples, the template may designate for synchronization a predetermined number of bytes within a certain range with an offset. For example, a template may indicate that a chunk should be 5 bytes long in range. The beginning of the chunk may include a specified offset, for example an offset of 2 bytes at the beginning of a file.

Additionally, or alternatively, the template may be selected based on a string of one or more characters within the file. For example, the chunk may include all bytes between two occurrences of a string. In other examples, the chunk may include all bytes between a first occurrence of two different strings. For example, to synchronize a DOCX file, the template created for the DOCX file may be defined such that the chunk includes all bytes between the strings <Dear John,> and <Sincerely,>.

Additionally or alternatively, the template may specify a schema, for example in XML. The file contents that match the schema are included in the chunking while other file contents not included in the schema are excluded from the chunk. Alternatively, file contents that match the schema are not included in the chunking while other file contents not included in the schema are included in the chunk. For example, to synchronize an XML file, the template created for the XML file may be defined such that the chunk includes all bytes between the strings <genre> and </genre>. In other words, the user of the file may have only changed an entry in the file associated with a genre and may desire to only update that portion of the file. In other examples, multiple chunking strategies may be combined in the same template.

The template based chunking strategies provided above are examples. Other template based chunking strategies may be used to partition a file.

Returning to the method of FIG. 3, once generated the template is provided to the client synchronization application 133. The client device 130 determines the location of the file stored in the local memory 134 (step 311) and provides the location of the file to the client synchronization application 133. In some cases, the client device 130 may provide a directory. Moreover, the client device determines the identity and remote location of the host device 110 to the client synchronization application 133 so that the synchronization application 113 may find and communicate with the host device 110 (step 312).

The client synchronization application 133, upon receiving the template, file location, and host location and identity, sends a sync request message to the host device 110 (step 313). The sync request message includes the template generated at template application 132. The host device 110 may continuously wait for a request from the client device 130 and synchronize any new request in real time.

Sending the template indicating a portion of the file to be updated instead of sending hashed chunks computed from the entire file reduces the amount of data transmitted to and from the host device 110. This method also reduces processing time at the client device 130 and the host device 110.

Upon receiving the template at the host device 110, the synchronization request triggers the host synchronization application 112 to begin chunking the file stored at the host device 110 (step 314). The chunking process splits the file into portions according to the template. The file portions may include data, source code, and/or metadata. At the client device 130, the file stored in the client memory 134 is partitioned into chunks based on selected portions defined by the template (step 315).

After each file is chunked into file portions, the host device 110 and the client device 130 determine whether the file portions located at each device are the same or different. To do so, the host synchronization application 112 and the client synchronization application 133 calculate the checksum for each of their respective file portions (steps 316 and 317). For example, the checksum may be a MD5 checksum. In some examples, a hash may be computed.

The host device 110 sends the checksum to the client device 130 (step 318). The checksum calculated at the host device 110 is compared to the checksum calculated at the client device 130 (step 319). If the checksums are the same there is a high probability that the two file portions are the same and will not require a file synchronization. When the checksums are different there is a high probability that the file portions are not the same. In this case, the client device 130 and host device 110 complete the synchronization process by transferring the updated chunk to the client device 130 or vice versa (step 320). The updated chunk portion is then matched with the file portion and replaced with the updated portion.

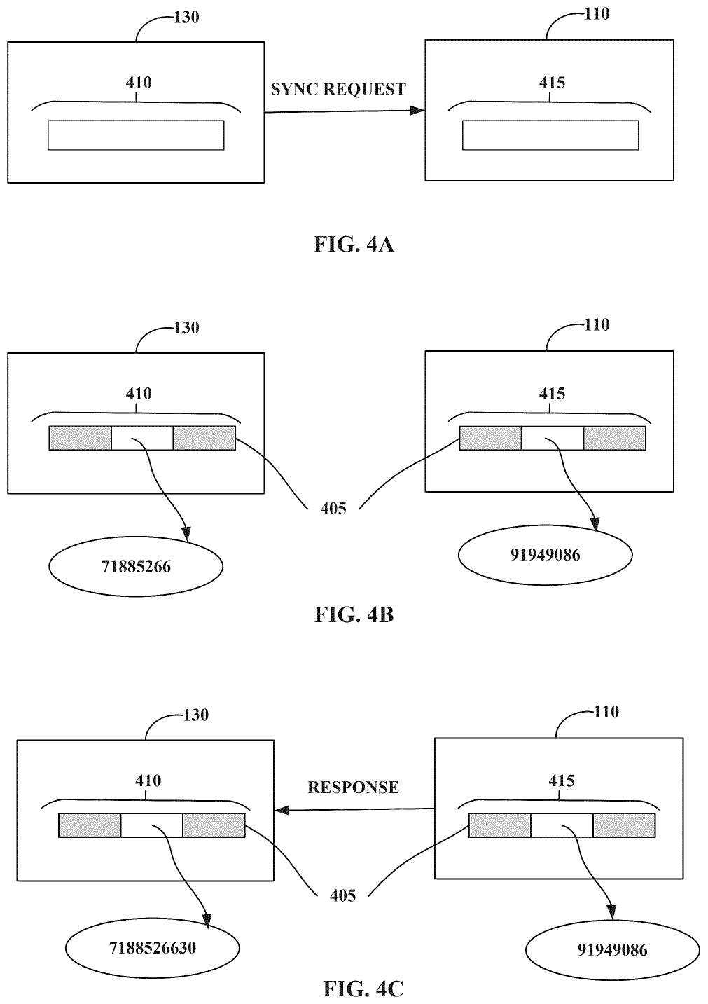

FIGS. 4A-E are schematic drawings illustrating the file synchronization process described in FIG. 3.

FIG. 4A illustrates a client device 130, including a client file 410, and a host device 110, including host file 415. The client file 410 and the host file 415 are not partitioned. The files may be any type of file, for example, a document or image file. The file format may include but is not limited to DOC, DOCX, PDF, HTML, HTM, XLSX, TXT, JPEG, PNG, SVG, WebP, Geo TIFF, HDF5, FITS, and NITF.

A synchronization request message, including a template, is sent to the host device 110. In this example, the client file 410 and host file 415 are XLS files containing multiple spreadsheets of varying sizes. The template designates a single spreadsheet at the center of the client file 410 for synchronization. Once the request is transmitted and received, the host device 110 partitions (i.e., chunks) the host file 415 into file portions 405, and the client device 130 partitions the client file 410 into file portions 405, as illustrated in FIG. 4B. The checksum is calculated only for the portion of the client file 410 and host file 415 that satisfies the template. In this example, the client synchronization application 133 and the host synchronization application 112 have identified the middle (white) portion of the client file 410 and the host file 415 for partitioning based on the template.

A checksum 71885266 is generated for the client file portion located at the client device 130. The checksum 91949086 is generated for the host file portion located at the host device 110. In response to the request, checksum 91949086 is transmitted to the client device 130 as illustrated in FIG. 4C. The client synchronization application 133 compares the checksum calculated at the client device 130 with the received checksum calculated at the host device 110. In this scenario, the checksums are different, and therefore, the host file portion at the host device 110 must be updated with the client file portion located at the client device 130. Accordingly, as illustrated in FIGS. 4D-4E, the updated version of the client file portion is transferred to the host device 110, and the outdated version of the host file portion stored at the host device 110 is replaced with the updated version stored at the client device 110.

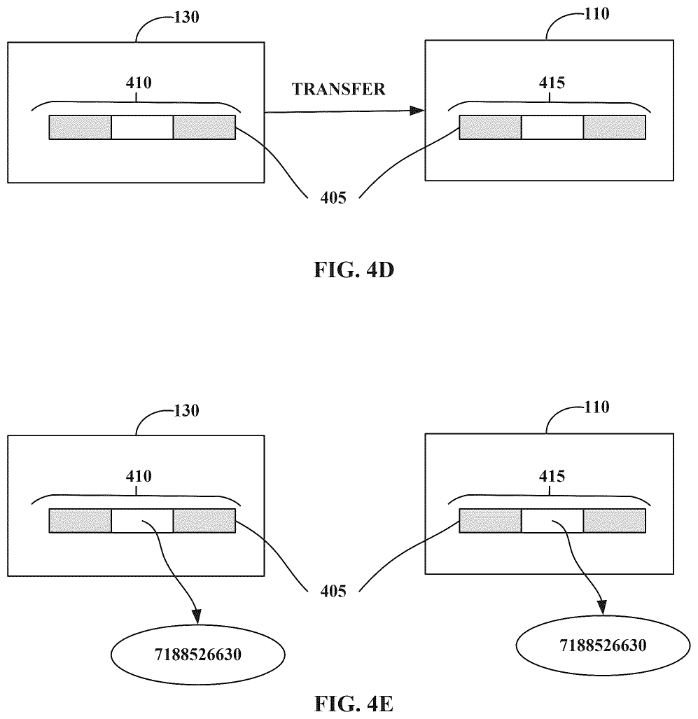

FIG. 5 is a flow chart illustrating a method of synchronizing files. A first file is partitioned into a first portion, and a second file is partitioned into a second portion based on a user-defined template (block 510). The size and locations of the first and second portions are indicated by the template. In some examples, the partition may include a portion of a file or the entire file. The first and second files may be partitioned into one or more parts depending on the file scheme indicated by the template.

The first file and the second file may contain multiple datasets. For example, the Microsoft Excel file format, xls, can contain numerous spreadsheets with varying sizes. In the image processing domain, where file types may include GeoTiff, HDF5, FITS, and NITF, it is common for a small amount of image metadata to exist within the same file as one or more large images. The template may indicate, for example, that the first and second portions only include a particular spreadsheet in an xls file or metadata in an image file.

In some examples multiple files in a directory of files may be partitioned. In some examples, the local location of the host file stored at the host device 110 is indicated by the client device 130 or the host device 110.

The first and second portions are compared based on a first checksum value and a second checksum value calculated for each of the first and second portions (block 520). The checksum of the first and second file portions is calculated using the same checksum algorithm. The checksum algorithms may include, for example, Fletcher's checksum, Adler-32, and cyclic redundancy checks (CRCs). If the checksum values do not match, it could indicate that the file portions are not the same. Additionally, or alternatively, a hash may be calculated for the first and second portions. Non-matching checksums could indicate that the file portions are not the same.

Either the first or second portion is updated based on the comparison when the first portion is different from the second portion (block 530). A copy of the first portion or second portions may be transmitted to the client device 130 or the host device 110. The copy replaces the current version of the respective portion of the file.

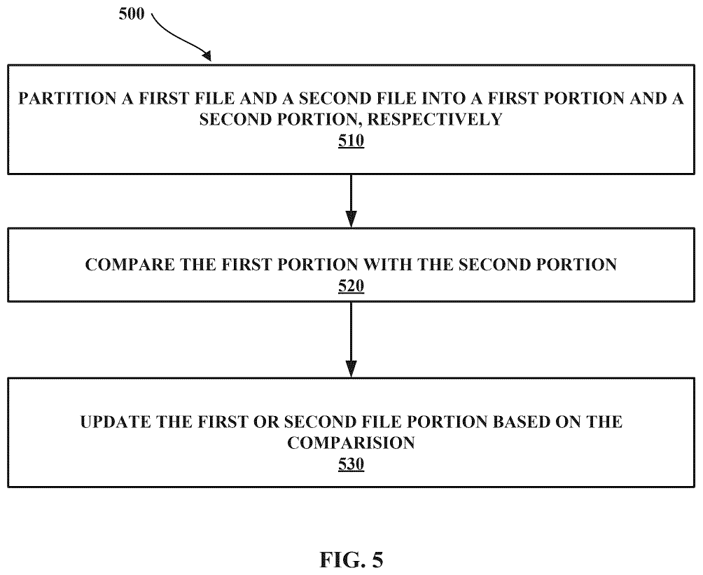

FIG. 6 is a flow chart illustrating another method of synchronizing files. The method includes selecting at least one portion of a first file (block 610). The selected portion of the first file identifies a subset of the first file that the user would like to update in the host memory 113 at the host device 110. A template identifying the selected portion of a first file is generated (block 620). The selected portions may include file data or metadata. The template is transmitted to the host device 110.

Upon transmission, the method further includes partitioning a first file and a second file into first and second portions, respectively (block 630). Receipt of the template at the host device 110 triggers the host sync application 112 to identify, using the template, a second file that is a copy of the first file. The second file is partitioned based on the template. The generation and/or transmission of the template will trigger the client sync application 113 to partition the first file based on the template.

The method further includes determining a first value representing the first portion and a second value representing the second portion (block 640). The host sync application 112 ran on the host device 110 is configured to determine the second value representing a second portion of the first file stored at the host memory 113 of host device 110. The client sync application 133 at the client device is configured to determine the first value representing the first portion of the first file stored in the local memory 134 at the client device 130. In some examples, the value may be a checksum value or a hash. Once the second value is calculated at the host sync application 110, it is transmitted back to the client device 130.

The method further includes comparing the first value and the second value (block 650). The client sync application 133 is configured to compare the first and second values to determine whether the values match. Matched first and second values indicate that the current versions of the first and second portions match. In this case, file synchronization is not needed. Mis-matched first and second values indicate that the first and second portions do not match. When the first and second values differ, synchronization is triggered. The first file portion is updated using the second file portion, or the second file portion is updated using the first file portion (block 660). The remainder of the first and second files that do not include the first and second portions are not updated.

Limiting the data transferred in the process is advantageous. Cloud providers charge per GB of data transferred. Accurately targeted data synchronization reduces the overall quantity of data transferred and may also reduce the number of accesses. It also saves time since only a small fraction of a file may need to be transferred.

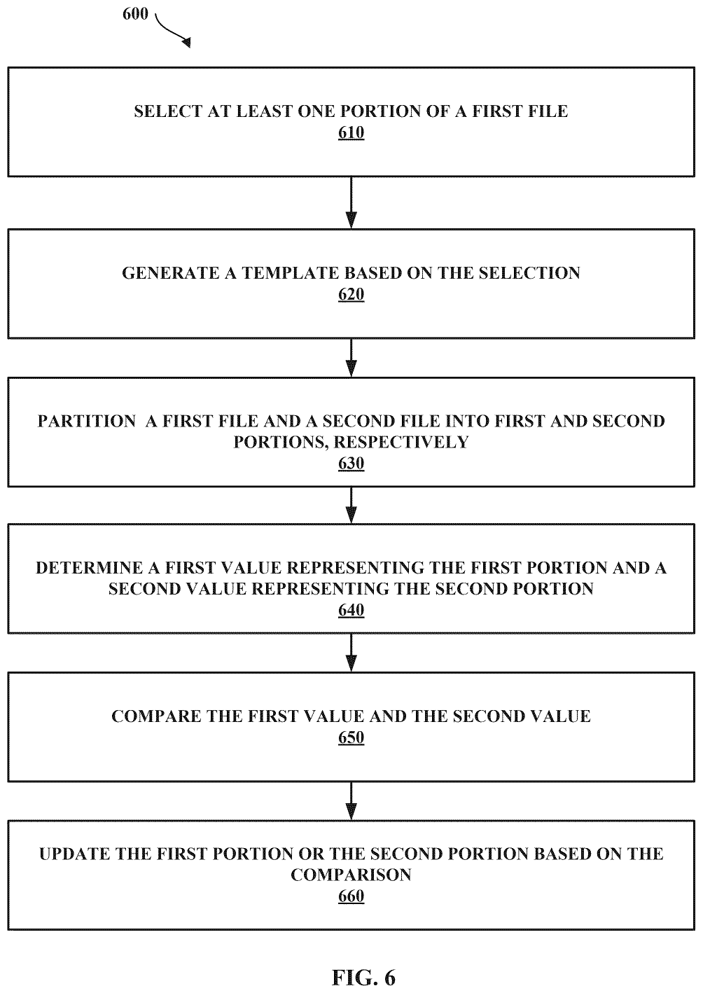

FIG. 7 is a schematic block diagram illustrating an exemplary host device 110. The host device 110 includes processing circuitry 710, memory circuitry 730, and interface circuitry 750. The processing circuitry 710 is communicatively coupled to the memory circuitry 730 and the interface circuitry 750, e.g., via one or more buses 720. The processing circuitry 710 includes one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. In one example, the processing circuitry 710 is programmable hardware capable of executing a software program 740 stored, e.g., as a machine-readable computer program 740 in the memory circuitry 730.

The memory circuitry 730 includes non-transitory machine-readable media, whether volatile or non-volatile, including but not limited to solid state media (e.g., SRAM, DRAM, DDRAM, ROM, PROM, EPROM, flash memory, solid-state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in various combination. The memory circuitry may store one or more software programs 740, for example, the host synchronization application 112.

In some examples, the interface circuitry 750 is a controller hub configured to control the input and output (I/O) data paths of the host device 110. Such I/O data paths may include data paths for exchanging signals over a communications network and data paths for exchanging signals with an electronic device or a user. For example, interface circuitry 750 includes a transceiver configured to send and receive communication signals over one or more of a network, Ethernet network, or optical network. In some examples, the interface circuitry 750 includes (or is communicatively connected to) one or more of a graphics adapter, display port, video bus, touchscreen, graphical processing unit (GPU), display port, Liquid Crystal Display (LCD), and Light Emitting Diode (LED) display, for presenting visual information to a user. In some examples, the interface circuitry 750 includes one or more of a pointing device (e.g., a mouse, stylus, touchpad, trackball, pointing stick, joystick), touchscreen, microphone for speech input, optical sensor for optical recognition of gestures, and keyboard for text entry.

The interface circuitry 750 may be implemented as a unitary physical component or as a plurality of physical components that are contiguously or separately arranged, any of which may be communicatively coupled to any other or may communicate with any other via the processing circuitry 710. In one example, the interface circuitry 750 includes output circuitry (e.g., transmitter 760 configured to send communication signals over the communications network) and input circuitry (e.g., receiver 770 configured to receive communication signals over the communications network and or a device sensor network). Similarly, the output circuitry may include a display, whereas the input circuitry may include a keyboard, touch screen, or card reader. Other examples, permutations, and arrangements of the above and their equivalents will be readily apparent to those of ordinary skill.

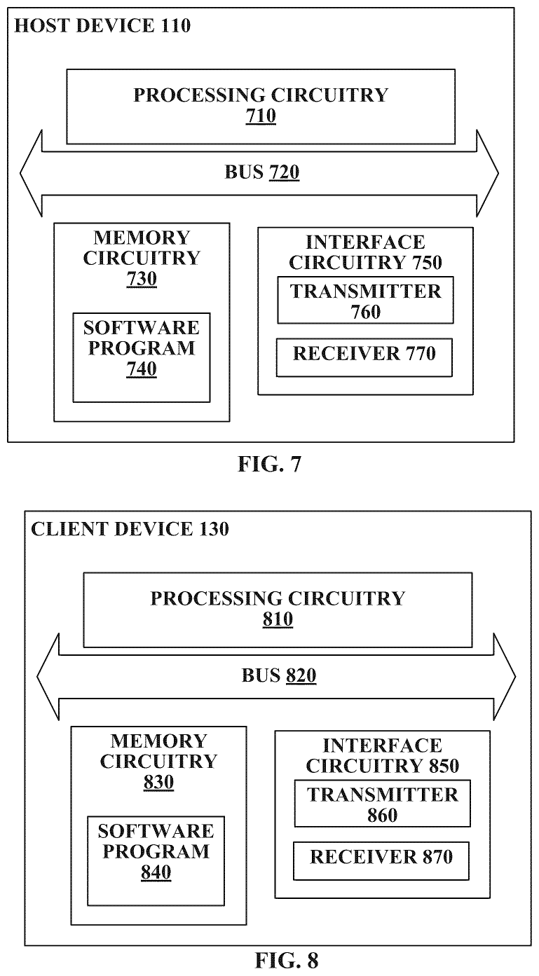

FIG. 8 is a schematic block diagram illustrating an exemplary client device 130. The client device 130 includes processing circuitry 810, memory circuitry 830, and interface circuitry 850. The processing circuitry 810 is communicatively coupled to the memory circuitry 830 and the interface circuitry 850, e.g., via one or more buses 820. The processing circuitry 810 includes one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. In one example, the processing circuitry 810 is programmable hardware capable of executing a software program 840 stored, e.g., as a machine-readable computer program 840 in the memory circuitry 830.

The memory circuitry 830 includes non-transitory machine-readable media, whether volatile or non-volatile, including but not limited to solid state media (e.g., SRAM, DRAM, DDRAM, ROM, PROM, EPROM, flash memory, solid-state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in various combination. The memory circuitry may store one or more software programs 840, for example, the client synchronization application 133.

In some examples, the interface circuitry 850 is a controller hub configured to control the input and output (I/O) data paths of the client device 130. Such I/O data paths may include data paths for exchanging signals over a communications network and data paths for exchanging signals with an electronic device or a user. For example, interface circuitry 850 includes a transceiver configured to send and receive communication signals over one or more of a network, Ethernet network, or optical network. In some examples, the interface circuitry 850 includes (or is communicatively connected to) one or more of a graphics adapter, display port, video bus, touchscreen, graphical processing unit (GPU), display port, Liquid Crystal Display (LCD), and Light Emitting Diode (LED) display, for presenting visual information to a user. In some examples, the interface circuitry 850 includes one or more of a pointing device (e.g., a mouse, stylus, touchpad, trackball, pointing stick, joystick), touchscreen, microphone for speech input, optical sensor for optical recognition of gestures, and keyboard for text entry.

The interface circuitry 850 may be implemented as a unitary physical component or as a plurality of physical components that are contiguously or separately arranged, any of which may be communicatively coupled to any other or may communicate with any other via the processing circuitry 810. In one example, the interface circuitry 850 includes output circuitry (e.g., transmitter 860 configured to send communication signals over the communications network) and input circuitry (e.g., receiver 870 configured to receive communication signals over the communications network and or a device sensor network). Similarly, the output circuitry may include a display, whereas the input circuitry may include a keyboard, touch screen, or card reader. Other examples, permutations, and arrangements of the above and their equivalents will be readily apparent to those of ordinary skill.

The present disclosure may, of course, be carried out in other ways than those set forth herein without departing from essential characteristics of the present disclosure. The present embodiments are to be considered in all respects as illustrative and not restrictive, and all changes coming within the meaning and equivalency range of the appended claims are intended to be embraced therein. Although steps of various processes or methods described herein may be shown and described as being in a sequence or temporal order, the steps of any such processes or methods are not limited to being carried out in any particular sequence or order, absent an indication otherwise. Indeed, the steps in such processes or methods generally may be carried out in various sequences and orders while still falling within the scope of the present disclosure.

While the concepts of the present disclosure are susceptible to various modifications and alternative forms, specific exemplary aspects of the disclosure have been shown by way of example in the drawings and are described in detail herein. It should be understood, however, that there is no intent to limit the concepts of the present disclosure to the particular forms disclosed, but on the contrary, the intention is to cover all modifications, equivalents, and alternatives consistent with the present disclosure and the appended claims.

1. A method of synchronizing files, the method comprising:
generating a template indicating a computer generated algorithm according to criteria set by a user, the algorithm indicating a specified schema for partitioning a selected portion of a first file and a second file;
partitioning, based on the template, the first file and the second file into a first portion and a second portion, respectively, wherein partitioning the first file and the second file comprises matching the specified schema defined in the template to content of the first file and the second file to generate the first portion of the first file and the second portion of the second file;
determining a first checksum of the first portion and a first value based on the first checksum;
determining a second checksum of the second portion and a second value based on the second checksum;
comparing the first value associated with the first portion with the second value associated with the second portion; and
updating the first portion or the second portion based on the comparing.

2. The method of claim 1, further comprising partitioning the first file and the second file based on one of a first N bytes of the first file and the second file, a last N bytes of the first file and the second file, or a N byte range with an offset in the first file and the second file.

3. The method of claim 1, further comprising partitioning the first file and the second file based on bytes between a first two occurrences of a string in the first file and the second file, or bytes between first occurrences of two different strings in the first file and the second file.

4. (canceled)

5. The method of claim 1, further comprising partitioning the first file and the second file based on file contents that do not match a specified schema defined in the template.

6. (canceled)

7. The method of claim 1, further comprising updating the first portion or the second portion responsive to the first value being different from the second value.

8. The method of claim 1, wherein updating the first portion or the second portion based on the comparing comprises one of: replacing, in a memory, the first portion with the second portion in the second file; or replacing, in the memory, the second portion with the first portion in the first file.

9. The method of claim 1, wherein updating the first portion and the second portion does not include updating a remainder of the first file or the second file.

10. A method of synchronizing files, the method comprising:
selecting at least one portion of a first file via user input;
generating a template indicating a computer generated algorithm based on the selecting;
partitioning, based on the template, the first file and a second file into a first portion and a second portion, respectively;
comparing a first checksum of the first portion and a second checksum of the second portion;
updating the first portion or the second portion based on the comparing.

11. The method of claim 10, wherein selecting the at least one portion of the first file comprises selecting at least one of: a first N bytes of the first file; a last N bytes of the first file; or a N byte range with an offset.

12. The method of claim 10, wherein selecting the at least one portion of the first file comprises selecting bytes between a first two occurrences of a string in the first file, or bytes between first occurrences of two different strings in the first file.

13. (canceled)

14. The method of claim 10, selecting the at least one portion comprises selecting first file contents that do not match a specified schema in the template and excluding other file contents that match the specified schema defined in the template.

15. (canceled)

16. The method of claim 10, further comprising updating the first portion or the second portion responsive to the first value being different from the second value.

17. The method of claim 15, wherein updating comprises one of: replacing, in a memory, the first portion with the second portion in the second file; or replacing, in the memory, the second portion with the first portion in the first file.

18. The method of claim 10, wherein updating the first portion and the second portion does not include updating a remainder of the first file or the second file.

19. A non-transitory computer readable medium storing a computer program product to synchronize files, the computer program product comprising software instructions that, when run, cause the computer program product to:
generate a template comprising a computer generated algorithm according to criteria set by a user, the computer generated algorithm indicating a specified schema for partitioning a first portion of a first file and a second portion of a second file;
determine a first checksum of the first portion and a first value based on the first checksum;
determine a second checksum of the second portion and a second value based on the second checksum;
compare the first value with the second value; and
responsive to the first value being different than the second value, replace the first portions with the second portions in the second file, or replace the second portions with the first portions in the first file.

20. The non-transitory computer readable medium of claim 19, wherein the computer program product replaces respective file portions of the first file or the second file without updating a remainder of the first file or the second file.

21. The method of claim 1, wherein the first file is stored on a first device and the second file is stored on a second device.

22. The method of claim 21, further comprises wherein the first file is stored on a first device and the second file is stored on a second device.

23. The method of claim 10, wherein the first file is stored on a first device and the second file is stored on a second device.

24. The method of claim 23, further comprises wherein the first file is stored on a first device and the second file is stored on a second device.
